(19) United States
(12) Patent Application Publication
(10) Pub. No.: US 2008/0257079 A1
(43) Pub. Date: Oct. 23, 2008

(54) INERTIAL PROPULSION DEVICE

(76) Inventor: Edvid Ivanovich LINEVICH, Vladivostok (RU)

Correspondence Address: DEFILLO & ASSOCIATES, INC., P.O. Box 14104, Clearwater, FL, 33766, US

(21) Appl. No.: 12/123,509

(22) Filed: May 20, 2008

Related U.S. Application Data
(63) Continuation-in-part of application No. 10/514,220, filed on Nov. 10, 2004.

(30) Foreign Application Priority Data
Dec. 23, 2002 (RU) 2002134855

(51) Int. Cl. F16H 33/00

(52) U.S. Cl. 74/61

(57) ABSTRACT

The present invention relates to a propulsion device including a housing, a rotation drive unit provided with an unbalanced weight, a control reverse unit for controlling reverse of the unbalanced weight, and at least one gyroscope made as a high speed rotating cylindrical body.

### CROSS REFERENCE TO RELATED APPLICATION

This application is a continuation-in-part of U.S. pending patent application Ser. No. 10/514,220 filed Nov. 10, 2004, which is a national stage of PCT/RU2003/000572, filed Dec. 22, 2003 and based upon Russian Application No. RU 2002134855, filed Dec. 23, 2002, under the International Convention.

### TECHNICAL FIELD

The invention relates to devices using inertia for moving objects, and can be used as a drive for example for vehicles and the like. The invention also can be adapted as a vibratory drive.

### BACKGROUND OF THE INVENTION

Different inertial propulsion devices using kinetic energy of rotating masses are known from prior art.

A device for conversion of centrifugal force to linear force and motion by Cook (U.S. Pat. No. 4,238,968) utilizes a pair of counter arms rotating about a common axle. One arm contains a mass splitable and transferable to the other arm and back again at one hundred and eighty degree intervals. It is impossible to control value of acceleration-braking of the rotating arms during one duty cycle of operation of the device.

A gyroscopic inertial space drive by Kellogg (U.S. Pat. No. 3,203,644) comprises a rotating mass mounted on a pivoted gimbal, motor means connected to the rotating mass adapted to angularly oscillate the rotating mass, a framework by one way drive clutch means to the gimbal. This one way drive clutch means provide movement of the framework when the gimbal is caused to process in one direction and is operative to disconnect the gimbal and framework when the gimbal precess in the opposite direction. In this drive, it is also impossible to control value of acceleration-braking of the rotating mass during one duty cycle of its operation. Also, relative positions between rotating elements of the device as well as positions of rotating elements of the device in the space do not allow to use Coriolis forces for the device to be more effectively.

### SUMMARY OF THE INVENTION

It is a primary object of the present invention to create an effective propulsion device having a reliable control system.

The inventive inertial propulsion device comprises a housing, a rotation drive unit provided with an unbalanced weight and made with the possibility of cyclical acceleration-braking. That is new that the propulsion device, in addition, comprises a control reverse unit for controlling reverse of the unbalanced weight, and at least one gyroscope made as a high speed rotating cylindrical body. Said gyroscope is connected to one of two devices of the rotation drive unit. Said devices are carried out with the possibility to rotate with power, one in relation to another, and to rotate freely in relation to the housing. The second device is carried out as the unbalanced weight, and besides the housing, is placed on an axis of the housing with the possibility of rotation around the housing axis and provided with a fixing means for elastic fixing an inclination of the gyroscope in its non-working position in relation to the housing axis, thus an axis of rotation of the gyroscope is not parallel, either with an axis of rotation of the devices of the rotation drive unit, or with the housing axis. Also, the control reverse unit has the possibility to control a position of the unbalanced weight and to operate in the middle of each duty cycle.

The devices of the rotation drive unit can be made as a rotor and a stator of an electric motor respectively. Thus the rotor is unbalanced concerning an axis of its rotation and is used as the unbalanced weight, and the stator is fixed rigidly on an axis installed on bearings coaxially to the rotor within the housing. Also, the gyroscope is fixed on the stator in such a manner that the axis of rotation of the gyroscope is located perpendicularly to the axis of rotations of the rotor.

The unbalanced weight can be carried out as a cylindrical body set on the rotor axially to the rotor with the possibility to rotate freely in relation to the rotor.

The rotation drive unit can comprise a hollow rotor covering radially the stator having a cavity. Also, the gyroscope is placed within the cavity thus the axis of rotation of the gyroscope is perpendicular to the housing axis.

A cross point of the axis of rotation of the gyroscope and the housing axis can coincide with the center of masses of the gyroscope.

The fixing means can have a lever, thus one end of the lever is rigidly connected to the axis of rotation of the stator, and the other end of the lever is spring-bias tangentially on two of its lateral sides in relation to the housing.

The control reverse unit can comprise at least one gauge for detecting an angular position of the center of masses of the unbalanced weight. The gauge is mounted on the housing on a plane, including both the housing axis and the axis of rotations of the rotor, so as to be displaced from this axis of rotations of the rotor. The control reverse unit also comprises a high-speed circuit changer for switching the direction of rotation of the electric motor. This high-speed circuit changer is provided with a power input, a power output, and control inputs. Windings of the electric motor are connected to the power output, an electric power supply is connected to the power input, and an output of the gauge is connected to one of the control inputs.

The control reverse unit can comprise a means for initial manual start-up of the electric motor, thus an output of said means is connected to one of the control inputs.

The electric power supply can have the possibility to change its capacity. It can be a pulse electric power supply, which may have the possibility to operate in a condition of a resonance with the electric motor.

The housing can be mounted on an axis of a vehicle.

### BRIEF DESCRIPTION OF THE DRAWINGS

The invention is described with references to the accompanying drawings.

FIG. 1 shows cross-sectional view of an inertial propulsion device which is taken along a plane of axis Z and Y.

FIG. 2 shows a cross-sectional view of the propulsion device of FIG. 1.

FIG. 3 shows a scheme illustrating a principle of an operation of the inventive device.

FIG. 4 shows a scheme of one of the variants of arranging the propulsion devices on a vehicle.

FIG. 5 shows a top view A of FIG. 4.

FIG. 6 shows a one-linear function chart of a control reverse unit for controlling an unbalanced weight.

FIG. 7 shows a simple scheme of one experiment confirming appearance of a driving force created by the device in accordance with the invention.

### DETAILED DESCRIPTION OF THE INVENTION

Following number references are used for drawings: 1—a gyroscope; 2—a case of the gyroscope; 3—a stator of an electric motor; 4 and 5—windings of the electric motor; 6—a rotor; 7—an unbalanced weight; 8—an axis of rotation of the unbalanced weight 7; 9—an axis of the stator; 10 and 11—bearings for rotation of the rotor 6 around the axis 9; 12—a housing of a propulsion device; 13 and 14—bearings of the case 12 for rotation around the axis 9; 15—a lever; 16—a platform of a vehicle; 17 and 18—bearings; 19—an axis of rotation of the case 12; 20—a gauge; 21—a gauge-mark of the rotor 6; 22 and 23—springs; 24—a current collector of the stator; 25—a current collector of the case; 26—a bearing for the rotation of the unbalanced weight 7 around the axis 8; 27—an experimental propulsion device; 28—a rope.

Following letter references are used for drawings: X, Y, Z—axis of ordinates, so the axis X coincides with an axis of rotation of the gyroscope 1, the axis Y coincides with the axis 9 of rotation of both the stator 3 and the rotor 6, and the axis Z coincides with the axis 19 of rotation of the case 12; M—a kinetic moment of the gyroscope 1; MII—a torque created by a drive unit; F—a tangential force effective on the unbalanced weight 7 and created by a drive unit; F̅—a tangential inertial force created by the unbalanced weight 7; r—radius of rotation of the center of masses of the unbalanced weight 7; a, b, c—points of a motion trajectory of the center of masses of the unbalanced weight 7 during a duty cycle; α—amplitude of angular oscillations of the unbalanced weight 7.

Works from the inventor showed that using a new approach to the definition of the motion force and inertia by using such inertia forces as Coriolis forces. Originality of this approach is the fact that the constructed concepts correlate with Newton's mechanics.

### THE EXAMPLE FOR CARRYING OUT THE INVENTION

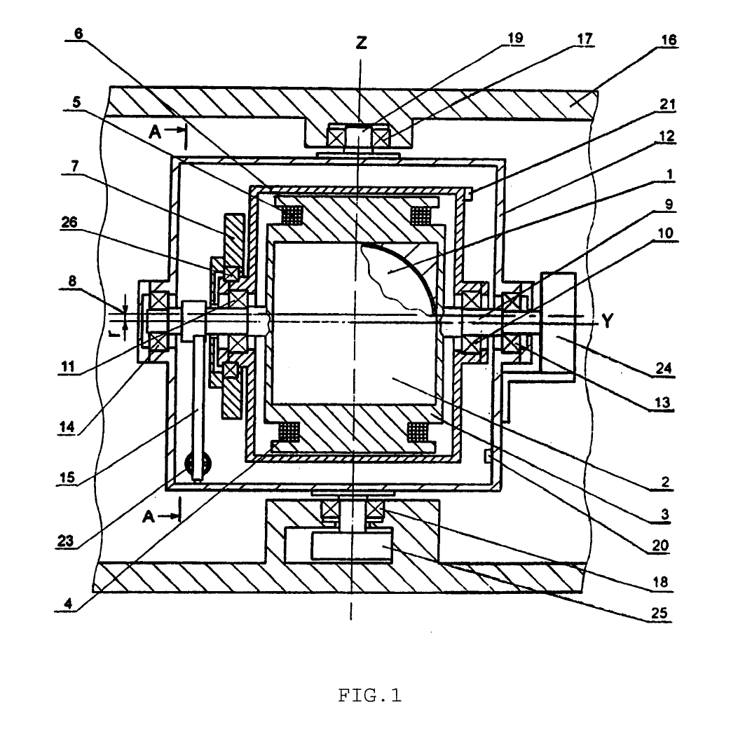

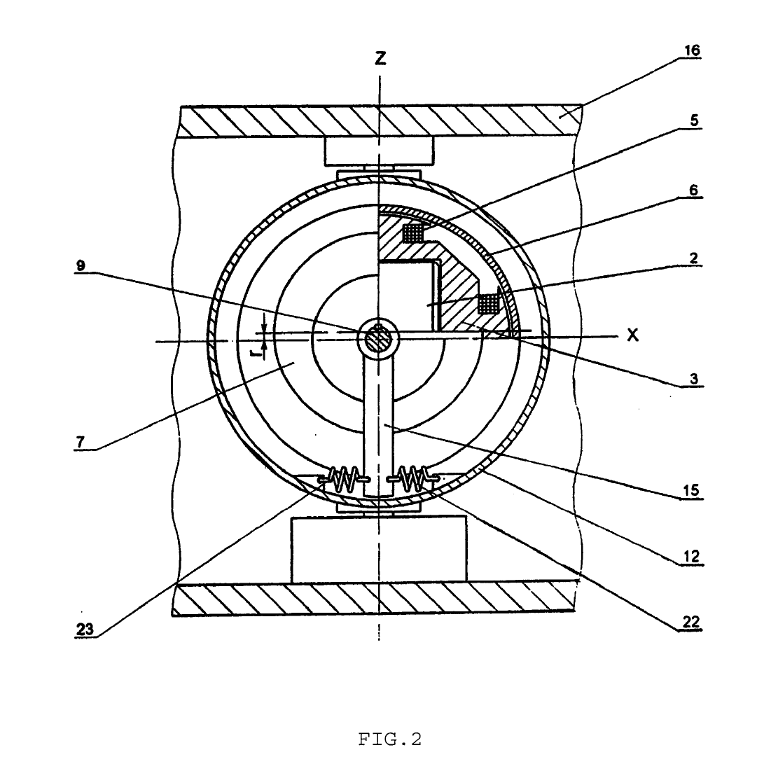

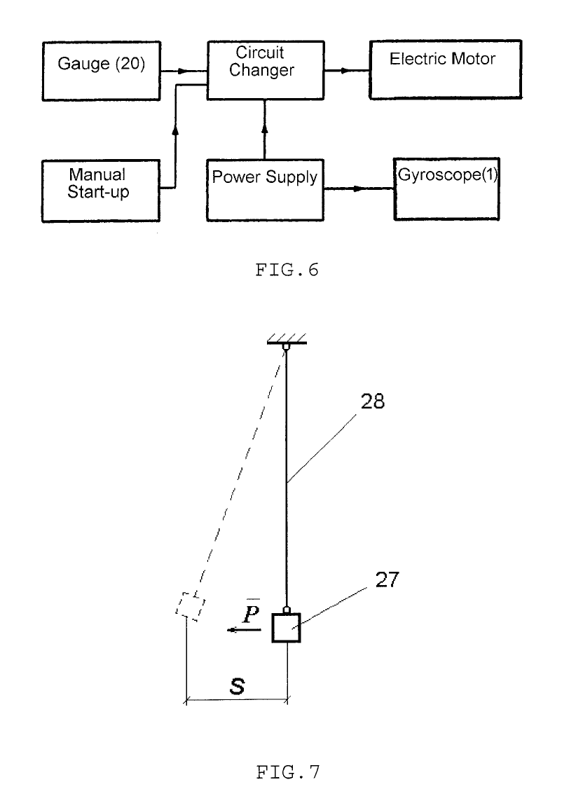

As it is shown on FIGS. 1, 2, the case 2 of the gyroscope 1 is fixed motionlessly with the stator 3. The rotor 6 can rotate freely, relative to the stator 3 and the axis 9 by means of the bearings 10, 11. Simultaneously the axis 9 may rotate freely in bearings 13, 14, relative to the case 12. Its rotation is restricted by the lever 15 fixed by springs 22, 23. These springs have a small rigidity and are intended for correctly fixing the gyroscope 1, relative to the axis 19 for a run-down state of the propulsion device. The unbalanced weight 7 is made of a heavy cylinder installed on the rotor 6 by the bearing 26 with the possibility of rotation. Its axis 8 is located with an eccentricity r, relative to the axis 9. The current collectors 24, are intended for feeding the power supply to both the windings of the electric motor and to a gyroscope, and also for signaling control from the gauge 20 of a control reverse unit (see FIG. 6). A source of power supplies is onboard the vehicle 16 and is not shown conditionally.

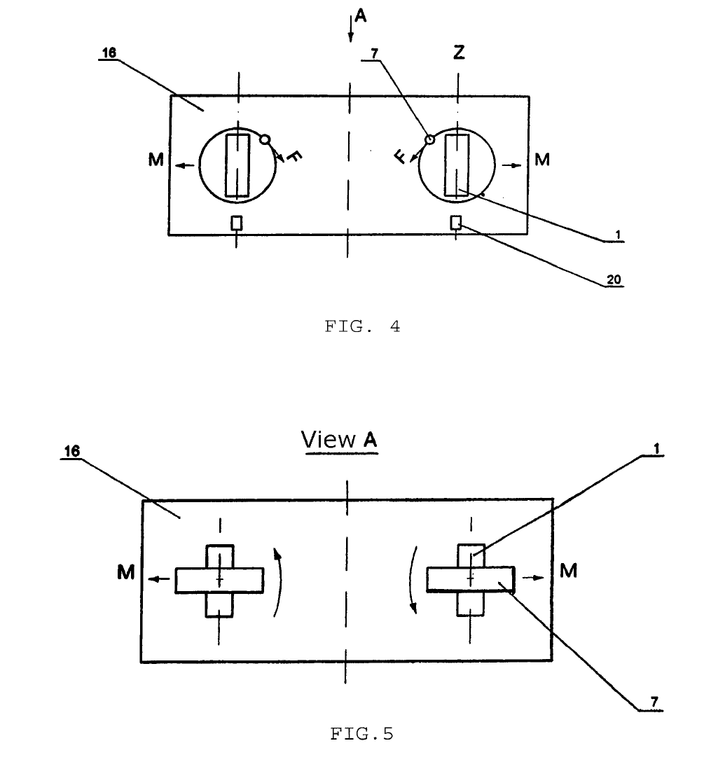

As it is shown on FIGS. 4 and 5 it is preferable to mount on the vehicle at least two similar inertial propulsion devices having elements moving symmetrically to remove vibration in a plane of the axis X, Y.

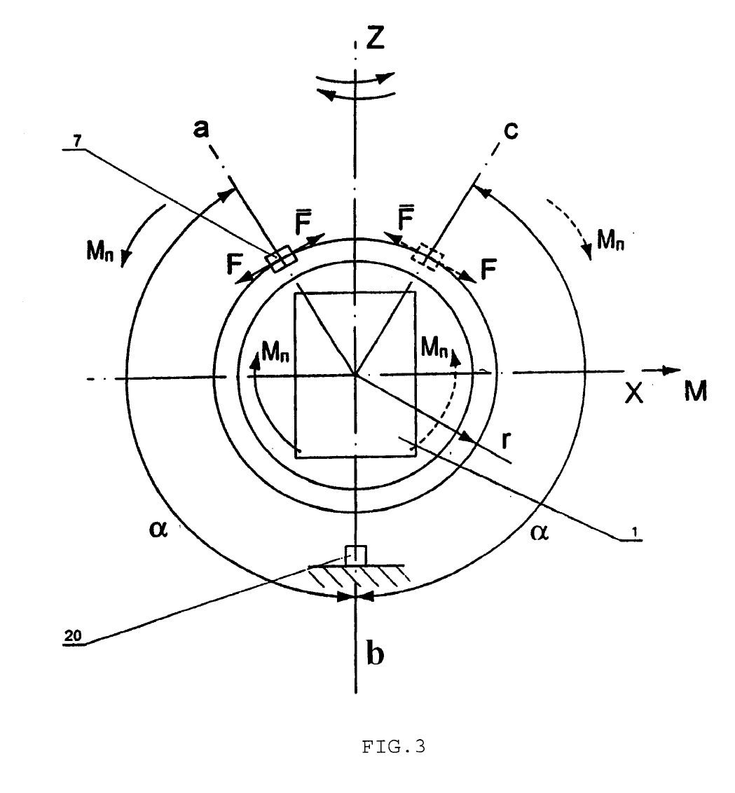

The inertial propulsion device operates as follows (see FIG. 3):

The source of power supplies connect to the gyroscope 1. A button “manual start-up” is pressed and released after the gyroscope 1 has obtained necessary rotation speed. As a result, the rotor 6 has obtained the necessary speed, and the unbalanced weight 7 has accumulated energy, thus the case 12 turns around the axis Z by means of a precession of the gyroscope 1. It is permissible that the unbalanced weight 7 goes from the point a to the point b. As soon as the center of unbalanced weight 7 appears opposite to the gauge 20 (in the point b), this gauge will submit a signal to a circuit changer, and the circuit changer will switch a direction of rotation.

Thus rotation of the unbalanced weight 7 will decelerate with emersion of the tangential force F by action of the constant torque MII, therefore it will appear the tangential inertial force F̅ directed to the contrary of the torque MII. The unbalanced weight 7 will stop for one instant in the point c, and then it will move in the opposite direction being accelerated by the action of the constant torque MII The unbalanced weight 7 will have the peak kinetic energy in the point b, at the same time a direction of rotation will be switched again by means of the gauge 20, and then the unbalanced weight 7 will decelerate by the torque MII with emersion of the tangential force F, and the opposite tangential inertial force will appear again. The unbalanced weight 7 will stop for one instant in the point a, where there will be another change of direction of the torque MII. The above-mentioned cycle of movement will be repeated. During operation of the propulsion device, the unbalanced weight 7 oscillates around the axis Y (the axis 9 on FIGS. 1, 2) with angular amplitude α, thus the housing 12 also oscillates around this axis Z (the axis 19 on FIGS. 1, 2). Both said angular amplitude and speed of said oscillation depend on both said kinetic moment M and said torque MII. During the cycle of oscillations, the tangential inertial force is directed mainly in the direction of the axis Z.

There are known theoretical and experimental properties of a gyroscope. The principle of an operation of the inventive propulsion device is grounded on these properties as follows:

(i) It is known that when an axis of a gyroscope is declined from an initial position by an outer moment, Coriolis forces create an opposite moment MII to turn the axis of the gyroscope into the initial position. The Coriolis forces appear due to complicate motion of points of the rotating gyroscope including the transportation motion and relative motion where, from one side, the transportation motion is oscillating motion of the unbalanced weight. In the invented device, the oscillating motion is declining the axis of the gyroscope periodically and creating periodic opposite moment MII. It is known that Coriolis forces created by this opposite moment MII lay in a plane which can not coincide with a plane of the oscillating motion of the unbalanced weight. A component of these Coriolis forces which is perpendicular to the plane of the oscillating motion can interact with a support (e.g. the Earth) via a housing of the device or via the housing and via a body of the vehicle. In this case, it is possible to create the liner driving force to move the vehicle (for example as for a device by Cook under the U.S. Pat. No. 4,238,968, or as for a device by Kellogg under the U.S. Pat. No. 3,203,644).

Other words, the first particular case is when some elements of the present invention interact with another body used us a support, a suspender and so on, in a plane which does not coincide with a plane of the oscillating motion of the unbalanced weight.

(ii) Another reason is based on the Coriolis forces as described above in the item (i). But, in this case, we need to consider the transportation motion as a rotation of the Earth (or another planet or a heavy body), and the invented device is located on the Earth or in the atmosphere rotating together with the Earth for this case. It is known for this case that the Coriolis force is proportional to the relative liner speed of the rotating points of the gyroscope and the transportation rotational speed of the Earth. Therefore, in this case, the gyroscope serves to add the energy of rotation of the Earth for creating opposite moment MII to converse oscillating motion of the unbalanced weight into the claimed liner driving force. In other words, the second particular case is when it is used interaction of the Earth rotation with the gyroscope which lays within a scope of physics laws.

The electric motor of the propulsion device creates the constant torque MII affixed on the one hand to the unbalanced weight 7 and on the other hand to the gyroscope 1 through the stator 3. By means of action MII, the unbalanced weight 7 is accelerated, and the gyroscope 1 processes with constant speed, i.e. rotates without acceleration together with both the stator 3 and the housing 12. It means that the above-mentioned external force appeared due to the above-mentioned interaction operates on the center of masses of the system “unbalanced weight—gyroscope” (hence, it operates on all devices). Said force is the Coriolis forces or their derivatives.

### Test

The purpose of the test was to determine the presence (or absence) of a driving force in the propulsion unit according to the present invention. The test was performed in a room with brick walls and concrete ceiling.

In this experiment, an experimental propulsion device 27 in accordance with the invention (the same as shown in FIGS. 1 and 2) was vertically suspended on a rope 28 of capron. The distance from the lower point of the propulsion device 27 to the upper point of the rope 28 fastening was 4.5 m. Total mass of the propulsion device was 55 kg. It was used an electric motor having a power 1500 W and a rotational speed 1,440 RPM as a drive of the propulsion device 27. It was used another electric motor having a power 120 W and a rotational speed 2,870 RPM as a drive of the gyroscope 1. Total mass of the unbalanced weight 7 was 15 kg, and total mass of the gyroscope 1 was 10 kg. An eccentricity of the unbalanced weight 7 was 0.0042 m. In the initial position, the drive of the propulsion device 27 was positioned manually in such manner that the assumed liner driving force vector was directed perpendicular to the rope 28, namely horizontally. The power of the drive of the gyroscope 1 was switched on. After the rotational speed of the gyroscope 1 reached the rated RPM, the power of the drive of the propulsion device 27 was switched on. There were performed five attempts, namely: two attempts in the north-south direction and three attempts in west-east direction. For each attempts, after the drives were switched on, deflection S of the rope 28 (shown by dotted line) was observed visually, and it was about 0.08-0.16 m from the initial lower point, which corresponded to the presence of a horizontal driving force P approximately equal to 15-20 N (about 1.5-2.0 kg). It was noted that the deflection value did not depend from orientations of the propulsion device 27 in the horizontal plane.

### Results

Nos.

| | 1 | 2 | 3 | 4 | 5 |
|---|---|---|---|---|---|
| Deflection (cm) | 8-14 | 10-15 | 11-16 | 10-14 | 9-15 |
| Time (Sec) | 30 | 25 | 45 | 40 | 32 |
| Driving Force (N) | 15.4 | 17.5 | 18.9 | 16.8 | 16.8 |

It necessary to underline that the propulsion device in accordance with the invention can be used also as a vibratory drive having performance values (speed of vibration; acceleration of vibration) which differ from the performance values of common vibratory drives due to existence of additional momentum and inertial forces creating by a gyroscope.

1. A propulsion device comprising:
a housing having an axis;
a rotation drive unit comprising a hollow rotor and a stator, the hollow rotor radially covering the stator, the stator having an opening;
an unbalanced weight fixed on the hollow rotor;
a control reverse unit for controlling the reverse of the unbalanced weight; and
at least one gyroscope located inside the opening of the stator, wherein the gyroscope has an axis of rotation perpendicular to the housing axis;
wherein the rotation drive unit and the control reverse unit oscillate the unbalanced weight by cyclical acceleration-breaking;
wherein the stator and the rotor rotate in relation to one another and freely rotate in relation to the housing;
wherein the rotor is placed on the axis of the housing and rotates around the housing axis and includes a fixing means for elastic fixing an inclination of the gyroscope in its non-working position in relation to the housing axis;
wherein the axis of rotation of the gyroscope is not parallel neither with the axis of rotation of the stator and rotor of the rotation drive unit nor with the housing axis.

2. The propulsion device of claim 1 wherein the stator is fixed rigidly on an axis installed on bearings coaxially to the rotor within the housing.

3. The propulsion device of claim 1 wherein a cross point of the axes of rotation of the gyroscope and the housing axis coincides with the center of masses of the gyroscope.

4. The propulsion device of claim 3 wherein the fixing means has a lever having a first end and a second end, wherein the first end of the lever is rigidly connected to the axis of rotation of the stator, and the second end of the lever is spring-bias tangentially on two of its lateral sides in relation to the housing.

5. The propulsion device of claim 1 wherein the control reverse unit comprises:
at least one gauge, wherein the gauge is mounted on the housing on a plane of both the housing axes and the axis of rotations of the rotor;
a high-speed circuit changer for switching a direction of rotation of an electric motor, and wherein the high-speed circuit changer includes a power input, a power output, and control inputs.

6. The propulsion device of claim 5 wherein the control reverse unit further comprises a means for initial manual start-up of the electric motor.

7. The propulsion device of claim 1 wherein the electric power supply is a pulse electric power supply.

8. The propulsion device of claim 7 wherein the electric power supply operates in a resonance with the electric motor.

9. The propulsion device of claim 1 wherein the housing is mounted on a vehicle in such manner that desired direction of movement of the vehicle does not coincide with a plane of the oscillating motion of the unbalanced weight.

10. The propulsion device of claim 1 wherein the housing axis is vertically placed.

11. The propulsion device of claim 10 wherein the propulsion device is vertically suspended.

12. The propulsion device of claim 1 wherein the gyroscope is provided with a drive of the gyroscope for rotation of the gyroscope around the axis of rotation of the gyroscope.
